(19) United States
(12) Patent Application Publication
(10) Pub. No.: US 2020/0309947 A1
(43) Pub. Date: Oct. 1, 2020

(54) TARGET RECOGNITION METHOD

(71) Applicant: TOYODA GOSEI CO., LTD., Kiyosu-shi (JP)

(72) Inventors: Mitsue TANAKA, Kiyosu-shi (JP); Bunpei MORITA, Kiyosu-shi (JP)

(21) Appl. No.: 16/795,788

(22) Filed: Feb. 20, 2020

(30) Foreign Application Priority Data
Mar. 26, 2019 (JP) 2019-058945

(51) Int. Cl. G01S 17/04; G01S 13/931

(52) U.S. Cl. CPC G01S 17/04; G01S 13/931

(57) ABSTRACT

A target recognition method includes setting different identifiers for different types of targets according to the types, setting, for each of the targets, a corresponding one of the identifiers such that the identifier is detectable using infrared light, providing an infrared-penetrable concealing layer so as to conceal the identifier from above the identifier, emitting the infrared light to the identifier arranged on the target, and recognizing the target based on the identifier that has been detected through the emitting.

### BACKGROUND

### 1. Field

The following description relates to a target recognition method for recognizing a target using infrared light.

### 2. Description of Related Art

Recent vehicles such as automobiles are equipped with infrared radar devices. The infrared radar device transmits infrared light and receives the reflected infrared light to detect another vehicle (target) that reflects the infrared light. However, the infrared radar device may not be able to detect a vehicle subject to detection. This occurs, for example, when the reflection efficiency of infrared light worsens depending on the color of the vehicle or depending on how dirty the vehicle is. Thus, to increase the reflection efficiency of infrared light, an onboard light reflector may be typically attached to a vehicle (refer to, for example, Japanese Laid-Open Patent Publication No. 2000-346943).

The onboard light reflector increases the reflection efficiency of infrared light. This allows the infrared radar device to detect the vehicle having the onboard light reflector with higher accuracy. However, in this case, the type of the vehicle cannot be recognized (identified). Recognizing (identifying) a vehicle type needs a vast amount of data and complicated calculation processing.

### SUMMARY

It is an objective of the present disclosure to provide a target recognition method capable of easily recognizing the type of a target.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A target recognition method that solves the above-described problem includes setting different identifiers for different types of targets according to the types, setting, for each of the targets, a corresponding one of the identifiers such that the identifier is detectable using infrared light, providing an infrared-penetrable concealing layer so as to conceal the identifier from above the identifier, emitting the infrared light to the identifier arranged on the target, and recognizing the target based on the identifier that has been detected through the emitting.

Other features and aspects will be apparent from the following detailed description, the drawings, and the claims.

### BRIEF DESCRIPTION OF THE DRAWINGS

FIG. 1 is a perspective view of a first vehicle with an infrared radar device arranged on the front part of the first vehicle.

FIG. 2 is a perspective view of a second vehicle (passenger car) in which circle marks are arranged as identifiers detectable by the infrared radar device.

FIG. 3 is an enlarged cross-sectional view of the main part shown in FIG. 2.

FIG. 4 is an enlarged cross-sectional view showing the main part of a second vehicle in which marks serving as identifiers detectable by the infrared radar device are arranged.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A target recognition method according to an embodiment will now be described with reference to the drawings.

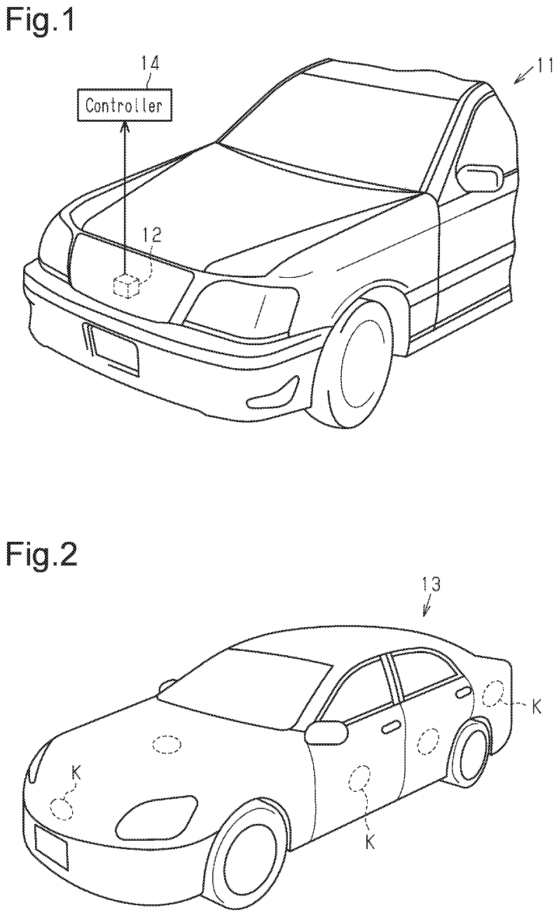

Referring to FIGS. 1 and 2, a first vehicle 11 has an autonomous driving function. The front end of the first vehicle 11 is provided with an infrared radar device 12 such that the infrared radar device 12 is invisible from the outside. The infrared radar device 12 is configured to transmit (emit) infrared light toward the front of the first vehicle 11 and receive the infrared light struck and reflected by, for example, a second vehicle 13. The second vehicle 13 is an example of a target outside the vehicle. As shown in FIG. 2, in the present embodiment, the second vehicle 13 is a passenger car. In the infrared radar device 12 of the present embodiment, infrared light having the wavelength of, for example, 800 nm to 1600 nm is used.

The infrared radar device 12 measures the distance between, for example, the host vehicle (first vehicle 11) and the front vehicle (second vehicle 13) and measures the relative speed with respect to the second vehicle 13 based on the transmitted infrared light (transmitted wave) and the received infrared light (received wave). The infrared radar device 12 is electronically connected to a controller 14 installed in the first vehicle 11. The controller 14 may be circuitry including: 1) one or more processors that operate according to a computer program (software); 2) one or more dedicated hardware circuits such as application specific integrated circuits (ASICs) that execute at least part of various processes; or 3) a combination thereof. The processor includes a CPU and memories such as a RAM and a ROM. The memories store program codes or commands configured to cause the CPU to execute processes. The memories, or computer readable media, include any type of media that are accessible by general-purpose computers and dedicated computers. The controller 14 executes various types of processes to support the driving of the vehicle 11 according to the environment of the vehicle 11 that is obtained from output signals of the infrared light radar device 12. The processes include a process of warning that the first vehicle 11 may deviate from the lane, a process of warning that the first vehicle 11 may collide, and a process of automatically adjusting the distance between vehicles.

The method for recognizing (identifying) the type of the second vehicle 13 by the controller 14 will now be described as the operation of the present embodiment.

First, different identifiers are set according to different vehicle types. In the present embodiment, the identifier of the passenger car (refer to FIG. 2) is set for circle mark K, the identifier of an emergency vehicle (not shown) is set for triangle mark K, and the identifier of a bus (not shown) is set for box mark K. The settings for these marks K (identifiers) are stored in advance in the controller 14 as tables. Marks K (identifiers) corresponding to the second vehicle 13 (circle marks corresponding to passenger car in the present embodiment) of the marks K set according to different vehicle types are arranged at the front part, the rear part, and the side parts of the second vehicle 13.

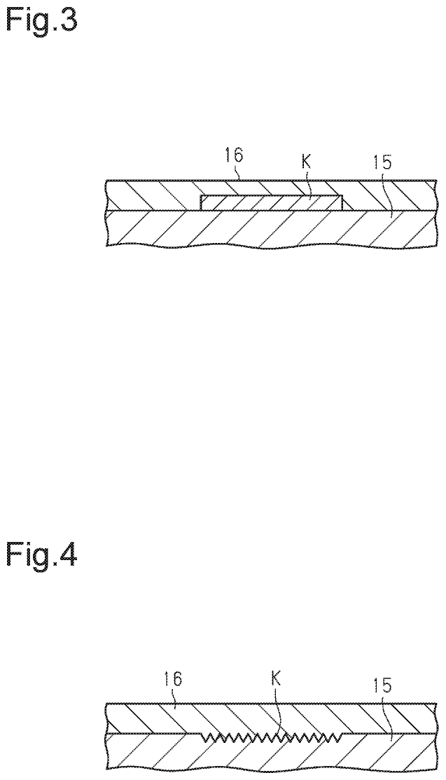

Referring to FIGS. 2 and 3, marks K serving as identifiers are made of materials that absorb infrared light, that is, paint that absorbs infrared light or films that absorb infrared light. That is, circle marks K serving as identifiers are arranged by applying, in a circular manner, the paint to a vehicle body 15 of the second vehicle 13 or by attaching the circular film to the vehicle body 15.

Subsequently, an infrared-penetrable paint is used to paint the entire vehicle body 15 from above circle mark K. This forms a coating 16. The coating 16 conceals circle mark K. In the present embodiment, the coating 16 is a concealing layer that conceals circle mark K. Thus, circle mark K is unrecognizable from the outside of the vehicle. While FIG. 2 shows circle marks K corresponding to the passenger car as identifiers arranged on the front part, rear part, and side parts of the second vehicle 13, triangle marks K and box marks K are respectively arranged on the emergency vehicle (not shown) and the bus (not shown) in the same manner as the passenger car.

When the infrared radar device 12 of the first vehicle 11 transmits (emits) infrared light to the second vehicle 13, the infrared light is reflected by the vehicle body 15 of the second vehicle 13 (passenger car) and absorbed in the regions of circle marks K. For this reason, in the region of the surface of the vehicle body 15 where the infrared light is transmitted (emitted), the regions where circle marks K (identifiers) are formed have a significantly lower reflection rate than the regions where circle marks K are not formed.

Accordingly, the controller 14 recognizes (identifies) the second vehicle 13 as the passenger car by detecting the circle shape from a received signal of infrared light reflected on the second vehicle 13 and checking the detected circle shape against the table. In the same manner as the case of the passenger car, the controller 14 recognizes (identifies) the second vehicle 13 as the emergency vehicle when detecting the triangle shape from a received signal of infrared light and recognizes (identifies) the second vehicle 13 as the bus when detecting the box shape from a received signal of infrared light.

The embodiment described above in detail has the following advantages.

(1) In the target recognition method, the type of the second vehicle 13 is recognized (identified) based on mark K (identifier) detected by transmitting (emitting) infrared light to mark K arranged on the second vehicle 13 (target). In this configuration, infrared light is used to detect mark K (identifier) that is concealed by the coating 16 and is unrecognizable. This eliminates the need for a huge amount of data (big data) and complicated calculation processing and thus allows the type of the second vehicle 13 to be easily recognized (identified). Accordingly, the vehicle type (type) of the second vehicle 13 is easily recognizable (identifiable) without degrading the appearance of the second vehicle 13.

(2) In the target recognition method, mark K (identifier) is made of a material that absorbs infrared light. In this configuration, in the region of the surface of the vehicle body 15 of the second vehicle 13 where infrared light is transmitted (emitted), the regions where circle marks K (identifiers) are formed have a significantly lower reflection rate than the regions where circle marks K are not formed. This ensures the detection of identifiers using the infrared light.

Modifications

The above-described embodiment may be modified as follows.

As shown in FIG. 4, mark K serving as an identifier may be formed by a region of recesses and projections that are formed on the surface of the vehicle body 15 of the second vehicle 13 by roughening the surface so as to disperse infrared light. In this configuration, in the region of the surface of the vehicle body 15 of the second vehicle 13 where infrared light is transmitted (emitted), the regions where marks K (identifiers) are formed have a lower reflection rate than the regions where marks K are not formed. This eliminates the need for, for example, paint that absorbs infrared light or a film that absorbs infrared light. The detection of mark K using infrared light is ensured.

The target does not have to be a vehicle and may be, for example, a ship, a drone, a mailbox, a traffic light, or a utility pole.

The color of the vehicle body 15 may be set to color such as dark blue or black that easily absorbs infrared light, and mark K (identifier) may be formed by paint or a film that easily reflects infrared light.

The number of marks K arranged on the second vehicle 13 nay be changed as long as the number is greater than or equal to one.

The infrared radar device 12 may be arranged on at least one of the front end, the rear end, the side parts, and the upper part such as the rooftop of the first vehicle 11. That is, for example, the infrared radar device 12 may be arranged on the front end and the rear end of the first vehicle 11, may be arranged on the front end, the rear end, and the side parts of the first vehicle 11, or may be arranged on the upper part such as the roof top.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A target recognition method comprising:
setting different identifiers for different types of targets according to the types;
setting, for each of the targets, a corresponding one of the identifiers such that the identifier is detectable using infrared light;
providing an infrared-penetrable concealing layer so as to conceal the identifier from above the identifier;
emitting the infrared light to the identifier arranged on the target; and
recognizing the target based on the identifier that has been detected through the emitting.

2. The target recognition method according to claim 1, wherein the identifier is made of a material that absorbs the infrared light.

3. The target recognition method according to claim 1, wherein the identifier is formed by a recess and a projection that are formed on a surface of the target so as to disperse the infrared light.
